(19) United States
(12) Patent Application Publication
(10) Pub. No.: US 2026/0216887 A1
(43) Pub. Date: Jul. 30, 2026

(54) MANAGEMENT DEVICE, MANAGEMENT SYSTEM, MANAGEMENT METHOD, AND MANAGEMENT PROGRAM

(71) Applicant: TELEXISTENCE INC., Tokyo (JP)

(72) Inventors: Genki SANO, Tokyo (JP); Pavel SAVKIN, Tokyo (JP); Takumi TACHIBANA, Tokyo (JP)

(73) Assignee: TELEXISTENCE INC., Tokyo (JP)

(21) Appl. No.: 18/706,783

(22) PCT Filed: Nov. 7, 2022
(86) PCT No.: PCT/JP2022/041336

§ 371 Date: Mar. 31, 2026

(30) Foreign Application Priority Data
Nov. 8, 2021 (JP) 2021-181883

(51) Int. Cl. B25J 13/06; B25J 9/16; B25J 19/02; G06F 3/04817; G06Q 10/087

(52) U.S. Cl. CPC B25J 13/06; B25J 9/1653; B25J 9/1669; B25J 9/1674; B25J 19/023; G06F 3/04817; G06Q 10/087

(57) ABSTRACT

A management device for managing a product replenishment robot which performs work including holding of a product is provided. The management apparatus includes a receiver unit for receiving a notification, etc. indicating that it is not possible to identify a product as a target of work, transmitted from the product replenishment robot, and a display control unit for enabling an operation screen to be displayed on a display unit based on receipt of a notification by the receiver unit. The operation screen includes a capture image captured by the product replenishment robot and instruction input user interfaces for accepting an instruction of an operator regarding a product shown in the capture image.

### TECHNICAL FIELD

The present disclosure relates to a management apparatus, a management system, a managing method, and a management program.

### BACKGROUND

JP2018-110755 discloses a product replenishment system for unmanned replenishment of products to reduce work labors. This product replenishment system has an image capture device for capturing images of products as replenishment targets, and a multi-joint robot apparatus for moving the products. The multi-joint robot apparatus picks up a product as a replenishment target which has been placed beforehand at a predetermined position to a product display shelf.

### SUMMARY

In the system as described in JP2018-110755, in some situations, the target product may not be recognized correctly depending on results of image capturing by the image capture unit. However, JP2018-110755 does not disclose what kind of measures are taken in such situations. The robot of JP2018-110755 is not operated by remote control. However, in a system where an operator at a remote location operates the robot, a mechanism which makes it possible to suitably provide an instruction for the robot as a control target is required. Such an issue is not limited to robots for replenishing products, but is a common issue in operating robots which automatically perform work including holding of products.

Under the circumstances, an object of the present disclosure is to provide a management apparatus, a management system, a management method, and a management program which make it possible for an operator to, when a predetermined error such as an event where a robot which automatically performs predetermined work cannot perform the work, occur, to easily recognize the situation and provide instructions for the robot suitably.

According to an aspect of the present invention, a management apparatus is provided. The management apparatus manages a robot which identifies a product as a target of work based on at least one of a capture image captured by an image capture unit and a detection result by a distance detection unit, and which performs work including holding of the identified product. The management apparatus includes a receiver unit for receiving a notification indicating a predetermined error transmitted from the robot, and a display control unit for enabling an operation screen to be displayed on a display unit based on receipt of the notification by the receiver unit. The operation screen includes a capture image captured by the image capture unit of the robot and an instruction input user interface for accepting an instruction of an operator regarding a product shown in the capture image.

According to the present disclosure, it is possible to provide a management apparatus, a management system, a management method, and a management program which make it possible for an operator to, when a predetermined error such as an event where a robot which automatically performs predetermined work cannot perform the work, occur, to easily recognize the situation and provide instructions for the robot suitably.

### BRIEF DESCRIPTION OF THE DRAWINGS

FIG. 1 is a view showing structure of a product replenishment system;

FIG. 2 is a plan view schematically showing layout of shelves in a store and a robot disposed in the store;

FIG. 3 is a view showing a product display shelf viewed from the front side;

FIG. 4 is a view showing the product display shelf viewed from the back side;

FIG. 5 is a block diagram showing structure of a product replenishment robot and a management apparatus;

FIG. 6 is a block diagram showing structure of a terminal device;

FIG. 7 is a flow chart showing processes performed in a case where the layout of the products of the product display shelf is changed;

FIG. 8 is a flowchart of product replenishment operation by the product replenishment robot;

FIG. 9 is an image of the product display shelf captured by the product replenishment robot;

FIG. 10 is an operation screen displayed on the terminal device;

FIG. 11 is an operation screen displayed on the terminal device;

FIG. 12 is a view showing an example of a guide frame of the product display shelf;

FIG. 13 is an operation screen displayed on the terminal device;

FIG. 14 is an operation screen displayed on the management apparatus;

FIG. 15 is an operation screen displayed on the management apparatus;

FIG. 16 is an operation screen displayed on the management apparatus;

FIG. 17 is an operation screen displayed on the management apparatus;

FIG. 18 is an operation screen displayed on the management apparatus;

FIG. 19 is an operation screen displayed on the management apparatus; and

FIG. 20 is an operation screen displayed on the management apparatus.

### DETAILED DESCRIPTION

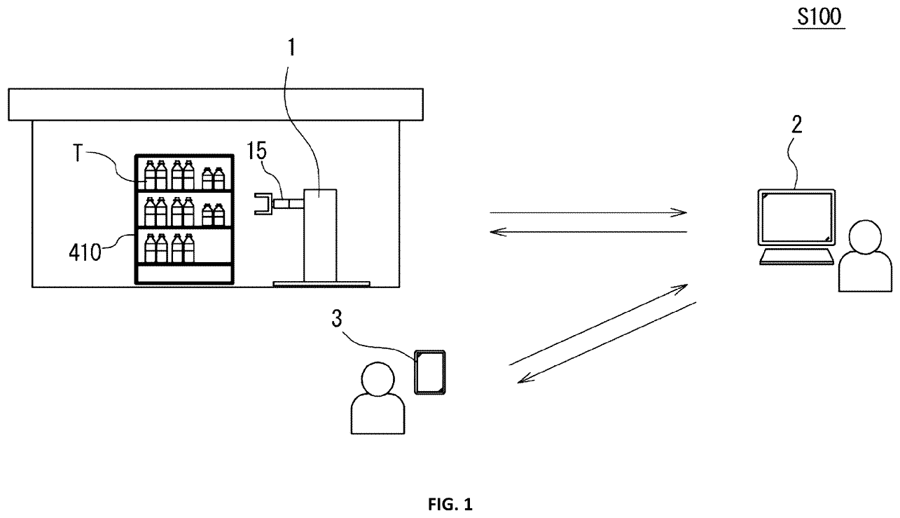

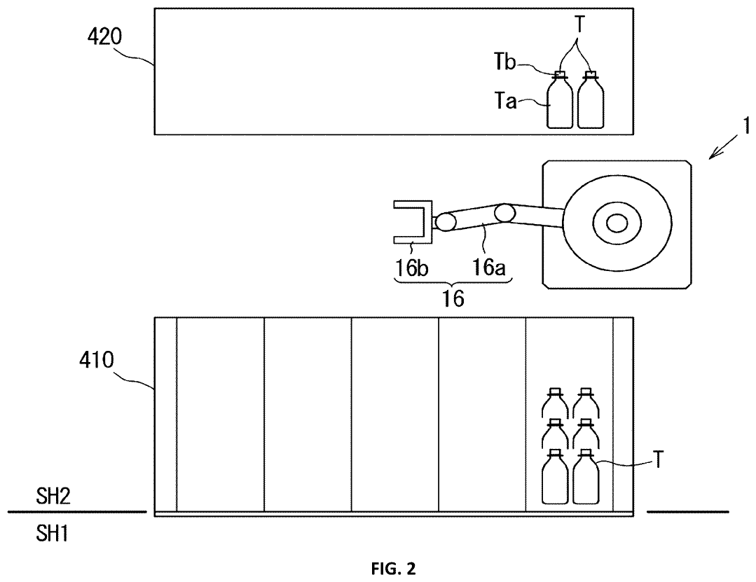

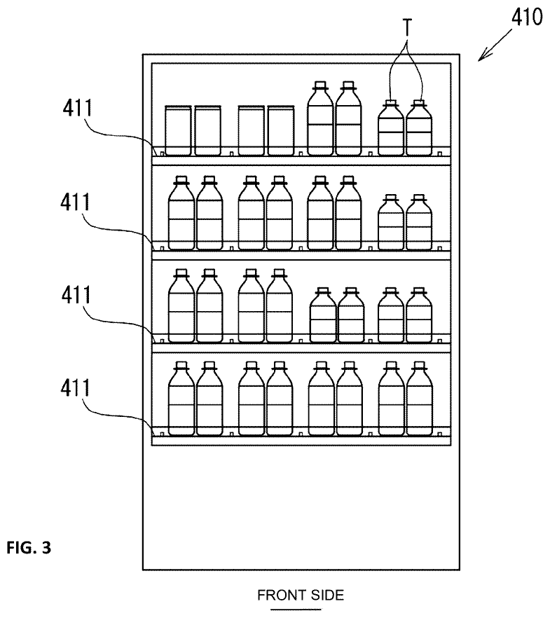

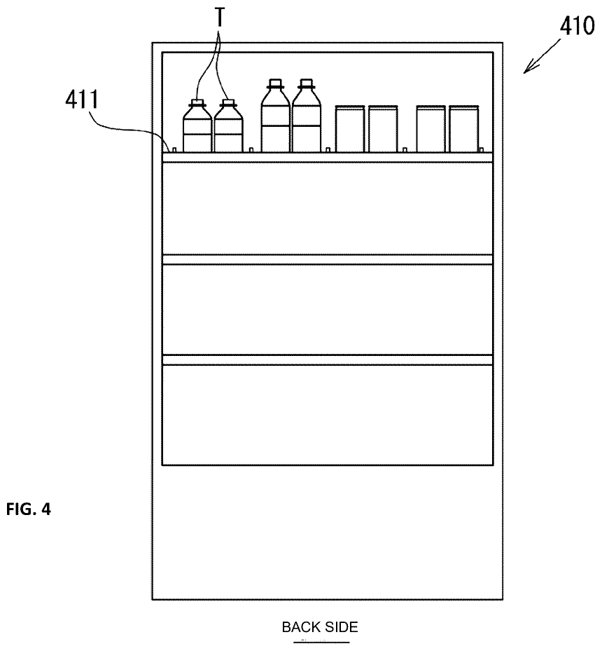

Hereinafter, embodiments of the present disclosure will be described with reference to the drawings. FIG. 1 is a view showing structure of a product replenishment system. FIG. 2 is a plan view schematically showing layout of shelves in a store and a robot disposed in the store. FIG. 3 is a view showing a product display shelf viewed from the front side. FIG. 4 is a view showing the product display shelf viewed from the back side.

In the present embodiment, as the robot, a product replenishment robot for replenishing products is given as an example. However, in addition to the product replenishment robot, for example, the present disclosure is applicable to various kinds of work robots having the function of holding a predetermined object. Such work robots include, for example, robots which hold products in logistics facilities and robots which hold predetermined products in factories, etc.

A product replenishment system S100 includes a product replenishment robot 1, a management apparatus 2, and a terminal device 3. The product replenishment robot 1 is disposed in a store, such as a convenience store, for example, and replenishes products T on a product display shelf 410. The management apparatus 2 is disposed at a remote location away from the store and is used by an operator at the time of operating the product replenishment robot 1 by remote control, for example. The terminal device 3 is a device used by a store employee in the store.

One of the features of the product replenishment system S100 is that in the case where the product replenishment robot 1 has failed to correctly recognize, for example, a product T, the product replenishment robot 1 transmits a notification indicating an error to the management apparatus 2, and then, the management apparatus 2 displays an operation screen including a user interface for the operator at the remote location to input instructions. The shape of the product T, the layout of the shelves in the store, and the specific structure of the product replenishment robot 1 are not limited specifically, but hereinafter, an example where the layout of the shelves as shown in FIG. 2 is adopted, and the product T is a beverage will be described.

For example, the product T is a beverage contained in a container such as a PET bottle, a bottle or a can. FIG. 2 depicts PET-bottle beverage products T. The product T has a container body Ta and a cap member Tb. The cap member Tb is a member which seals the container body Ta, and for example, is formed of a non-transparent material. The product T may be a canned beverage without a cap member.

### Shelf Layout in the Store

The store has an in-store space SH1 and a backyard space SH2. The in-store space SH1 is a space where customers select and purchase the products T. The backyard space SH2 is a space where stocks of the products T are stored. A product display shelf 410, a stock shelf 420, and the product replenishment robot 1 are disposed in the store.

As shown in FIGS. 3 and 4, the product display shelf 410 has a plurality of shelf plates 411a to 411d (also referred to as levels of the product display shelf). A plurality of types of products T are arranged on the shelf plate 411. For example, the same type of products T are arranged in two rows or three rows. The products T may be arranged only in one row. The front side of the product display shelf 410 faces the in-store space SH1. So, customers can take products T from the front side of the product display shelf 410. The shelf plate 411 is inclined such that the front side gets lower relatively. In the structure, when a customer takes a product T from the front side, other products T arranged behind the product T slide on the shelf plate 411, and move toward the front side.

The back side of the product display shelf 410 faces the backyard space SH2. So, the store employee or the product replenishment robot 1 can replenishes the product display shelf 410 with the products T from the back side of the product display shelf 410. Although not shown in the drawings, doors may be provided on the front and back sides of the product display shelf 410. Though only one product display shelf 410 is drawn in FIG. 2, a plurality of product display shelves 410 may be disposed in the store.

The stock shelf 420 is disposed in the backyard space SH2, to face the product display shelf 410. That is, the front side of the stock shelf 420 and the back side of the product display shelf 410 face each other. Like the product display shelf 410, the stock shelf 420 has a plurality of shelf plates (levels) arranged in the height direction. Replenishment target products as products to be replenished on the product display shelf 410 are placed on the shelf plate 421 of the stock shelf 420. The replenishment target products may be arranged by the store employee or the product replenishment robot 1.

### Structure of the Product Replenishment Robot 1

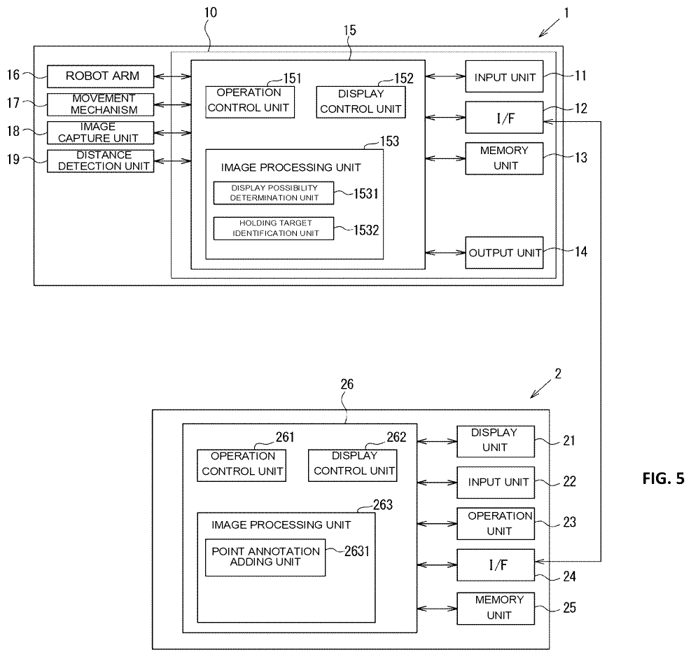

As shown in the block diagram of FIG. 5, the product replenishment robot 1 includes a control device 10, a robot arm 16, a movement mechanism 17, an image capture unit 18, and a distance detection unit 19. The product replenishment robot 1 may include both of the image capture unit 18 and the distance detection unit 19, or may include only one of the image capture unit 18 and the distance detection unit 19.

As shown in FIG. 2, the robot arm 16 includes an arm unit 16a and a holder unit 16b. The arm unit 16a is a multi-joint robot arm having a plurality of link members. The holder unit 16b includes a pair of holder members for holding a target object, for example. The pair of holder members have a shape configured to hold the product T which is a PET bottle beverage at a position near the cap member Tb. Further, the pair of holder members have a shape configured to hold an outer peripheral portion of the product T which is a canned beverage. The holder unit 16b may not be formed by the pair of holder members. Alternatively, the holder unit 16b may be configured to hold a target object by adsorption or may be configured to hold a target object by using an adhesive force, a magnetic force, etc.

The movement mechanism 17 includes an actuator such as a motor and a transmission mechanism to move the robot arm 16 to an arbitrary position in a space between the product display shelf 410 and the stock shelf 420. The movement mechanism 17 may have, for example, one or both of an elevation mechanism and a horizontal movement mechanism. The elevation mechanism is a mechanism which moves the robot arm 16 vertically. The horizontal movement mechanism is a mechanism which moves along a rail placed in the store, for example, and moves the robot arm 16 horizontally.

The image capture unit 18 includes an imaging element which captures images of the product display shelf 410 and/or the stock shelf 420, and generates a capture image (e.g., RGB image). One image capture unit 18, or a plurality of image capture units 18 may be provided. The image capture unit 18 outputs the generated capture image data to the control device 10. The image capture unit 18 is provided at an arbitrary position of the product replenishment robot 1. In the case where the product replenishment robot 1 has a movable mechanism (not shown) which can change its orientation according to the movement of the operator at the remote location, the image capture unit 18 may be attached to the movable mechanism. In this case, since the image capture unit 18 moves according to the movement of the operator, the operator can orient the image capture unit 18 toward the desired image capture target to capture an image of the image capture target.

The image capture unit 18 may be attached to the robot arm 16, for example. By changing the orientation of the robot arm 16, the image capture unit 18 can capture images of the product display shelf 410 and the stock shelf 420. As the image capture unit 18, a first camera (not shown) and a second camera (not shown) may be provided. As a more specific example, the robot arm 16 may have a first camera oriented to capture the image of the product display shelf 410 and a second camera oriented to capture the image of the stock shelf 420.

The distance detection unit 19 is a depth sensor (distance sensor) for measuring data of the distance (distance data) to the product T. One or more distance detection units 19 may be provided. The distance detection unit 19 may be disposed adjacent to the image capture unit 18. The distance detection unit 19 detects one or both of the product display shelf 410 and the stock shelf 420 as detection targets. The distance detection unit 19 outputs the obtained distance data to the control device 10. For example, the distance detection unit 19 may use devices of a stereo lens system or a LiDAR (Light Detection and Ranging) system.

The control device 10 includes an input unit 11, an interface unit 12, a memory unit 13, an output unit 14, and a control unit 15 (see FIG. 5).

The input unit 11 is a device such as a keyboard, a mouse, or a touch panel for providing input to a computer. The interface unit 12 is a communication interface for transmitting and receiving data to and from external devices. For example, the interface unit 12 functions as a receiver unit for receiving notifications transmitted from the product replenishment robot 1. The control device 10 is communicatively connected to the management apparatus 2 through a network (not shown) such as the Internet. The control device 10 may be communicatively connected to the terminal device 3.

The memory unit 13 includes a storage medium such as a ROM (Read Only Memory), a RAM (Random Access Memory), and an HDD (Hard Disk Drive). The memory unit 13 stores a computer program executed by the control unit 15. The memory unit 13 may store the following data to enable the robot arm 16 to hold the target product T and move the held product to the product display shelf 410: One item or a plurality of items of data related to the product display shelf 410 (e.g., shape data, position data, or lane coordinate data), data related to the stock shelf 420 (e.g., shape data, position data, or lane coordinate data), and data related to the product T (e.g., shape data, position data).

The output unit 14 is provided for allowing the product replenishment robot 1 to output an alert to the store employee. For example, the output unit 14 is one of, or a combination of a speaker, a display, a light emitting device, or a vibration device.

For example, the control unit is a CPU (Central Processing Unit 15). The control unit 15 functions as an operation control unit 151, a display control unit 152, and an image processing unit 153 by executing the computer program stored in the memory unit 13. The operation control unit 151 controls operation of the output unit 14, the robot arm 16, the movement mechanism 17, the image capture unit 18, and the distance detection unit 19, etc. The operation control unit 151 transmits the image data generated by the image capture unit 18 to the management apparatus 2 via the interface unit 12. The image data may be a still image or a video (including a format of stream video in which image data captured by the image capture unit 18 is transmitted to the outside in real time).

In the case where a display is provided as the output unit 14, the display control unit 152 controls display functions of the display.

The image processing unit 153 has a display possibility determination unit 1531 and a holding target identification unit 1532. All of these functional units are processing units which perform predetermined data processing based on the capture image data captured by the image capture unit 18 of the product replenishment robot 1 and/or the distance data obtained by the distance detection unit 19 while the product replenishment robot 1 is performing a series of product replenishment operations.

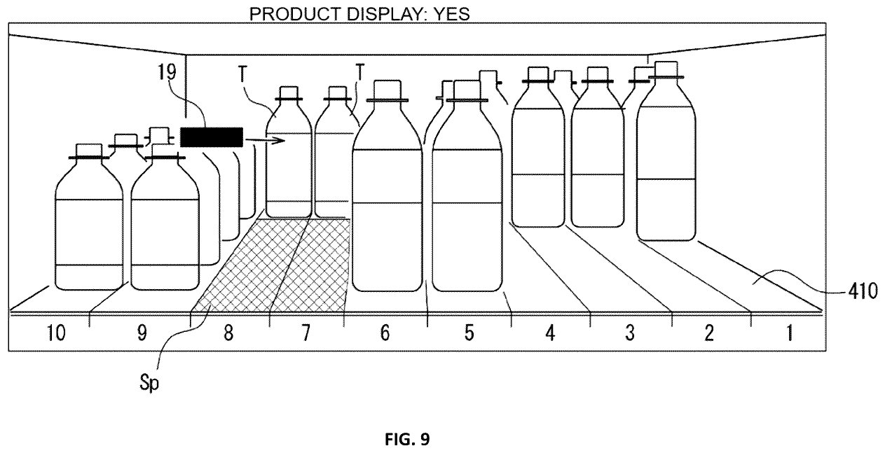

Based on at least one of the capture image data generated by the image capture unit 18 and the distance data obtained by the distance detection unit 19, the display possibility determination unit 1531 determines, for example, whether or not a space Sp (see FIG. 9) is present to place more products behind the rearmost product T arranged on the product display shelf 410. If the space Sp is present, it means that the product T needs to be replenished. Therefore, if the space Sp is present, the product display possibility determination unit 1531 transmits a notification indicating that the product T should be replenished, to the operation control unit 151. In the case where the operation control unit 151 receives this notification, the operation control unit 151 performs replenishment operation for the product T. In the case where the display possibility determination unit 1531 cannot determine the presence or absence of the space Sp, the display possibility determination unit 1531 transmits a notification indicating that the presence or absence of the space Sp cannot be determined, to the management apparatus 2 through the interface unit 12.

Based on at least one of the capture image generated by the image capture unit 18 and the distance data obtained by the distance detection unit 19, the holding target identification unit 1532 performs at least one of determination of whether or not the replenishment target product as a holding target is present in the stock shelf 420, identification of the size or shape of the replenishment target product, and determination of a holding position of the replenishment target product. In the case where the product T has the cap member Tb as shown in FIG. 2, for example, the holding target identification unit 1532 sets a position near the cap member Tb as the holding position. In the case where the product T does not have the cap member Tb, the holding target identification unit 1532 may set a side portion of the container as the holding position.

For example, in the case where the holding target identification unit 1532 cannot determine whether or not a replenishment target product is present on the stock shelf 420, the holding target identification unit 1532 transmits a notification indicating that it is not possible to determine whether or not the replenishment target product is present, to the management apparatus 2 via the interface unit 12. In the case where it is not possible to identify the size of the replenishment target product, in the case where it is not possible to identify the shape of the replenishment target product, or in the case where it is not possible to determine the holding position of the replenishment target product, the holding target identification unit 1532 transmits a notification indicating that it is not possible to identify the size of the replenishment target product, it is not possible to identify the shape of the replenishment target product, or it is not possible to determine the holding position of the replenishment target product, to the management apparatus 2 via the interface unit 12.

While the functions of the various parts of the control unit 15 (the operation control unit 151, the display control unit 152, and the image processing unit 153) have been described above, as long as the processes are performed by the control unit 15, a process performed by one functional unit may be performed by another functional unit.

### Regarding the Management Apparatus 2

The management apparatus 2 includes a display unit 21, an input unit 22, an operation unit 23, an interface unit 24, a memory unit 25, and a control unit 26.

The display unit 21 is a display showing various items of information. The display unit 21 may be a touch panel display. The display unit 21 may be a head mounted display worn on the head of the operator. The input unit 22 is a device such as a keyboard, a mouse, or a touch panel, for providing input to the computer. The operation unit 23 is a device for remotely controlling the product replenishment robot 1. The operation unit 23 may be, for example, a handle, a lever, a pedal, a button, etc. The operation unit 23 may be a voice input device, such as a microphone, or a gesture input device which recognizes body or hand movements of the operator. The interface unit 24 is a communication interface for transmitting and receiving data to and from external devices.

The management apparatus 2 is communicatively connected to the product replenishment robot 1 and the terminal device 3. Although FIG. 1 shows a diagram in which one product replenishment robot 1 in one store is connected to one management apparatus 2, a plurality of product replenishment robots 1 in a plurality of stores may be connected to the management apparatus 2. That is, one management apparatus 2 may remotely control the product replenishment robots 1 in a plurality of stores.

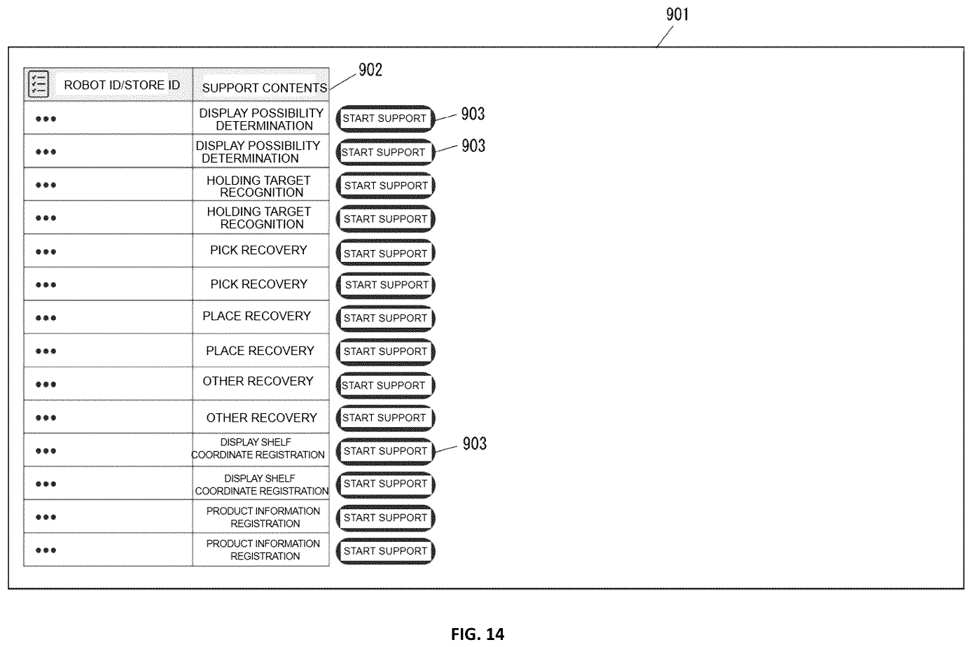

The memory unit 25 includes a storage medium such as a ROM (Read Only Memory), a RAM (Random Access Memory) and an HDD (Hard Disk Drive). The memory unit 25 stores a computer program to be executed by the control unit 26. The memory unit 25 stores data of an application for the operator to support the operator in replenishing products by the product replenishment robot 1. Specifically, the memory unit 25 stores data of a graphical user interface described later. The memory unit 25 may store, in association with the user ID of the operator, a list of the identification information of the store for which the operator is in charge of management, the identification information of the product replenishment robot 1 installed in the store, and task information of the operator (details will be described with reference to FIG. 14).

For example, the control unit 26 is a CPU (Central Processing Unit). By executing a computer program stored in the memory unit 25, the control unit 26 functions as an operation control unit 261, a display control unit 262, and an image processing unit 263. The operation control unit 261 is a functional unit which controls the basic operation of the management apparatus 2. For example, based on the input to the operation unit 23, the operation control unit 261 generates a control signal to control the product replenishment robot 1, and transmits the generated control signal to the product replenishment robot 1 via the interface unit 24.

The display control unit 262 controls display functions of the display unit 21. Specifically, in the case where the display control unit 262 receives a predetermined notification from, for example, the product replenishment robot 1 via the interface unit 24, or in the case where the operator makes a predetermined input to the input unit 22, the display control unit 262 changes the display contents of the display unit 21 as necessary.

The display control unit 262 enables a predetermined operation screen (user interface) to be displayed on the display unit 21 based on receipt of a notification from an external device such as the product replenishment robot 1 or the terminal device 3. “The configuration where the display control unit enables the operation screen (user interface) to be displayed based on receipt of a notification” may be a configuration where the operation screen is displayed on the display unit 21 when the control unit 26 receives the notification, or may be a configuration where the operation screen is displayed on the display unit 21 only after the control unit 26 receives the notification, and then, some further input (e.g., operation by the operator). In this specification, the same applies to cases where such expressions are used with respect to processes other than those described above.

For example, the image processing unit 263 has a point annotation adding unit 2621. The point annotation adding unit 2621 analyzes the image of the back side of the product display shelf 410 captured by the product replenishment robot 1 to identify the coordinates of each lane. The point annotation adding unit 2621 may identify the coordinates of the product on the product display shelf 410. The point annotation adding unit 2621 may add an image, such as a dot, to a position in the image corresponding to the identified coordinates.

### Regarding the Terminal Device 3

The terminal device 3 has a display unit 31, an input unit 32, an interface unit 33, a memory unit 34, an image capture unit 35, and a control unit 36. For example, the terminal device 3 is a tablet type terminal used by the store employee in a store.

The display unit 31 is a display which displays various items of information. The display unit 31 may be a touch panel display. In this case, the touch panel corresponds to the input unit 32. The input unit 32 may be provided with a microphone, etc. in addition to the touch panel. The interface unit 33 is a communication interface for transmitting and receiving data to and from external devices. The terminal device 3 is connected to one or both of the management apparatus 2 and the product replenishment robot 1 through an arbitrary network.

The memory unit 34 includes a storage medium such as a ROM (Read Only Memory), a RAM (Random Access Memory), and a HDD (Hard Disk Drive). The memory unit 34 stores computer programs to be executed by the control unit 36. The memory unit 34 stores data of a graphical user interface described later. The memory unit 34 stores data of applications for the store employee described later. The image capture unit 35 is a camera which generates still or video image data.

The control unit 36 is, for example, a CPU (Central Processing Unit). By executing the computer programs stored in the memory unit 34, the control unit 36 functions as an operation control unit 361, a display control unit 362, and an image processing unit 363. The operation control unit 361 controls operation of various parts of the terminal device 3, including the image capture unit 35. The display control unit 362 controls display functions of the display unit 31. The image processing unit 363 is a functional unit for executing one of applications for the store employee, and includes a guide frame identification unit 3631. When the store employee captures an image of the product display shelf 410, the guide frame identification unit 3631 superimposes a guide frame on an image being captured by the image capture unit 35, and displays the image on the display unit 31.

### Flow in the Case Where Products on the Display Shelf are Changed, and Flow of Operation by the Product Replenishment Robot

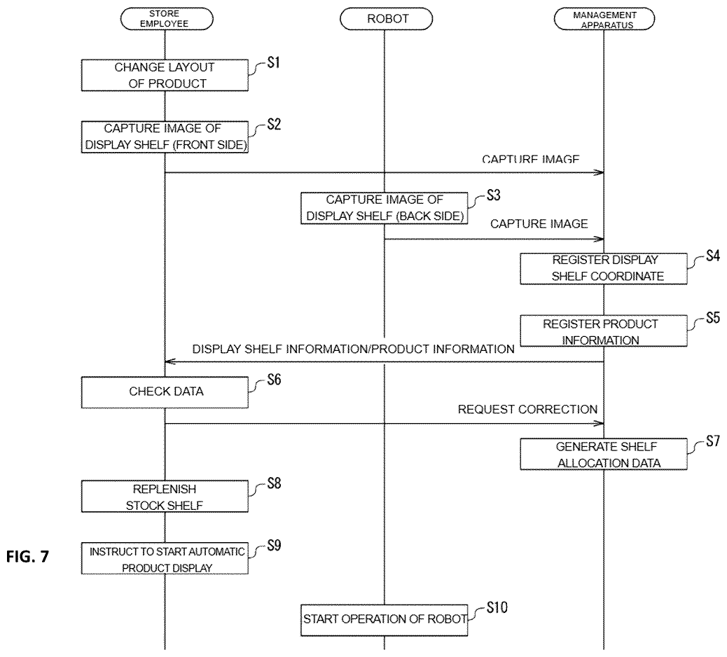

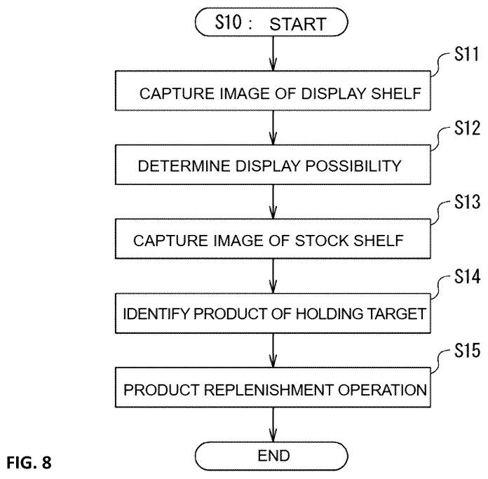

The flow in the product replenishment system S100 having the structure as described above will be described with reference to FIGS. 7 and 8. FIG. 7 is a flow chart showing processes used in a case where the layout of the products T (see FIG. 1) of the product display shelf 410 is changed by the store employee. FIG. 8 is a flowchart of product replenishment operation by the product replenishment robot 1.

In the product replenishment system S100 of the present embodiment, various user interfaces are used in each process of the flowcharts of FIGS. 7 and 8. The details of the user interface will be described later with reference to the other drawings. Firstly, the overall flow of the operation according to the flowcharts in FIGS. 7 and 8 will be described briefly below. It should be noted that the “shelf allocation data” herein means data indicating which products are placed in which lanes of the product display shelf.

For example, in the case where a new beverage product is introduced or there is a renewal of the products handled, it is necessary to update the shelf allocation data. Hereinafter, a series of processes in which a store employee captures an image of a display shelf using the terminal device 3, transmits the captured image to the management apparatus 2, and an operator on the part of the management apparatus 2 registers the shelf allocation data will be described. Firstly, in step S1, the store employee changes the layout of the products T on the product display shelf 410.

Then, in step S2, the store employee captures an image of the front side of the product display shelve 410 using the terminal device 3. The store employee does not have to capture images of all of the product display shelves 410 in the store, and the store employee captures an image of only the product display shelve for which the product layout has been changed. As for the user interface displayed on the terminal device 3 at the time of capturing the image of the product display shelf 410, the details will be described later with reference to other drawings. The captured image of the product display shelf 410 is transmitted from the terminal device 3 to the management apparatus 2.

Next, in step S3, the product replenishment robot 1 captures an image of the back side of the product display shelf 410 and transmits the image of the back side of the product display shelf 410 to the management apparatus 2. This operation of capturing the image by the product replenishment robot 1 may be started, for example, when a store employee provides a start instruction for the product replenishment robot 1, or when an operator at a remote location provides a start instruction for the product replenishment robot 1 through the management apparatus 2.

Next, in step S4, the operator registers the display shelf information (information about the number of shelf levels and lanes) using the management apparatus 2. The operator also registers product information using the management apparatus 2 (step S5). Then, the operator transmits the registered display shelf information and product information from the management apparatus 2 to the terminal device 3.

Next, in step S6, the store employee checks the display shelf information and product information transmitted by the management apparatus 2, at the terminal device 3. As necessary, the store employee sends a request for correction of registration information from the terminal device 3 to the management apparatus 2. Next, in step S7, the operator creates the final shelf allocation data using the management apparatus 2 and stores the data in the memory unit 25 of the management apparatus 2.

Next, in step S8, the store employee replenishes the stock shelf 420 with products T to allow the product replenishment robot 1 to automatically perform the replenishment operation of the products T. Next, in step S9, the store employee operates the product replenishment robot 1 to start the replenishment operation (automatic product display). It should be noted that the start of the replenishment operation does not necessarily have to be instructed by the store employee, and the instruction may be given by the operator through the management apparatus 2. Next, in step S10, the product replenishment robot 1 starts the replenishment operation of the product T.

### Product Replenishment Operation by the Product Replenishment Robot

The replenishment operation of the product T by the product replenishment robot 1 is performed in the following manner. Hereinafter, an example where the image capture unit 18 and the distance detection unit 19 are provided on the robot arm 16 will be described. Firstly, in step S11, the product replenishment robot 1 captures an image of the back side of the product display shelf 410. The product replenishment robot 1 moves the robot arm 16 in a manner that the image capture unit 18 and the distance detection unit 19 can capture an image of a predetermined level of the product display shelf 410. Next, the product replenishment robot 1 operates the image capture unit 18 to obtain an image of the back side of the product display shelf 410 and operates the distance detection unit 19 to obtain data of the distance (distance data) to the products T arranged on the product display shelf 410. Then, in step S12, it is determined whether or not the product can be displayed. The “display possibility determination” is a step of determining which products T can be displayed (in other words, which products T need to be replenished) by analyzing the image of the back side of the product display shelf which has been captured by the product replenishment robot 1. The product replenishment robot 1 obtains the image of the back side of the display shelf 410 as shown in FIG. 9. Since the product replenishment robot 1 can obtain data of the distance to the product T from the distance detection unit 19, it is possible to recognize the presence of a space Sp behind the product T for items such as the products T in lanes “7” and “8”, where the number of displayed products has been decreased. The product replenishment robot 1 determines whether or not there is the space Sp for the product T based on the data of the distance to the product T, and whether or not more products T can be displayed in the lanes “7” and “8”. By the process of step S12, it is determined which products T on the product display shelf 410 need to be replenished.

The method of determining whether or not products need to be replenished is not limited to the method described above, and various methods can be used. For example, it may be possible to determine what percentage of the products T are arranged in a given three-dimensional space and determine that the products T need to be replenished if the value is less than a predetermined standard value.

Next, in step S13, the image of the stock shelf 420 is captured. The product replenishment robot 1 operates the robot arm 16 and the image capture unit 18, etc. to capture the image of the stock shelf 420 from the front side. For example, the product replenishment robot 1 captures the image of the stock shelf 420 one level at a time to obtain the captured image showing the stock status of the product T. It is not essential to perform image capturing of the stock shelf 420 after the image of the product display shelf 410 is captured, and image capturing of the stock shelf 420 may be performed before the image of the product display shelf 410 is captured.

Next, in step S14, the product replenishment robot 1 analyzes the image of the stock shelf 420 obtained in step S13 to identify the products arranged on the stock shelf 420 and identify the holding position, etc. By the processes up to this point, information indicating which products T at which positions on the product display shelf 410 need to be replenished, the positions of the replenishment target products on the stock shelf 420 corresponding to the products T, and the holding positions of the replenishment target products are obtained by the product replenishment robot 1.

Next, in step S15, the product replenishment robot 1 performs product replenishment operation (pick-and-place operation) based on the above obtained information. Specifically, the operation control unit 151 of the control unit 15 of the product replenishment robot 1 (see FIG. 5) operates the movement mechanism 17 and the robot arm 16 to move the holder unit 16b toward a predetermined product replenishment target on the stock shelf 420. Then, the holder unit 16b holds the previously identified holding position of the replenishment holding target product, and then, lifts replenishment target product. Then, the operation control unit 151 operates the robot arm 16 to move the held product T to a predetermined placement position on the display shelf 410, and releases the product T from the holder unit 16b to place the product T at a predetermined position. Thereafter, the replenishment robot 1 repeats the pick-and-place operation in the same manner to complete replenishment of the products T.

The above series of processes is the basic operation of the product replenishment robot 1 for automatically replenishing the products T from the stock shelf 420 to the product display shelf 410. In the present embodiment, in the case where, in such a series of processes, for example, the product replenishment robot 1 (a) failed to determine whether or not the products can be displayed, (b) failed to recognize the product on the display shelf, or (c) failed to identify the holding position of the product, the product replenishment robot 1 transmits a notification to the management apparatus 2, and an operation screen (user interface) is displayed on the management apparatus 2 to enable the operator to provide predetermined support.

In the present embodiment, one of technical features is the operation screen displayed on the management apparatus 2. However, since various operation screens are used in various processes of the overall workflow in the product replenishment system S100, hereinafter, the specific operation screens will be described with reference again to the flowchart shown in FIG. 7. In the following description, it is assumed that there are four product display shelves in the store, and these product display shelves are indicated on the operation screen as “DISPLAY SHELF 1” to “DISPLAY SHELF 4”. Further, unless otherwise needed, products, the product display shelves, and the stock shelves will be described without any signs.

Firstly, in step S1 (see FIG. 7), the store employee changes the layout of the products on a predetermined product display shelf. In this example, it is assumed that the layout of some products on the “DISPLAY SHELF 1” has been changed.

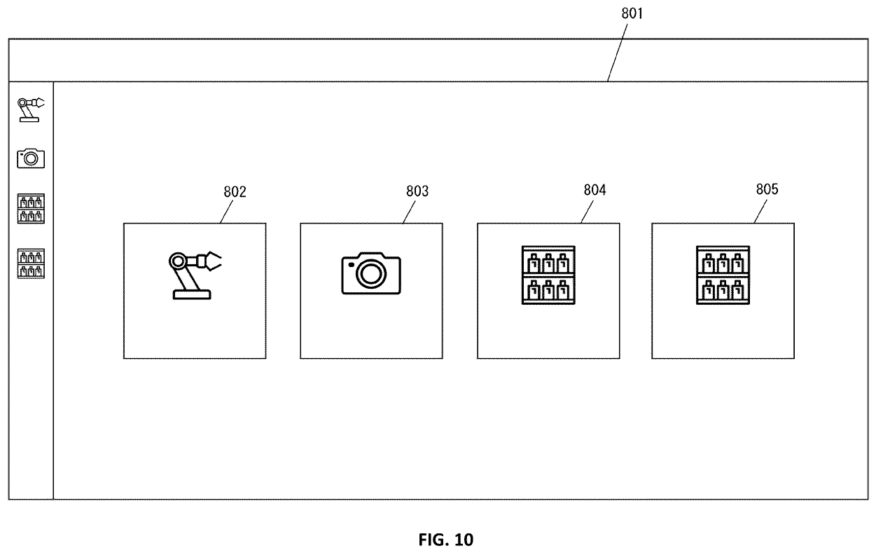

Next, in step S2, the store employee captures an image of the front side of the “DISPLAY SHELF 1” where the layout of the products has been changed. Specifically, for example, the store employee starts an application for the store employee on the terminal device 3 and inputs a user ID and a login password. After the terminal device 3 authenticates the user based on the user ID and the login password inputted by the store employee, an operation screen 801, as shown in FIG. 10, is displayed on the display unit 31.

The operation screen 801 is a user interface including a robot management icon 802, a display shelf image capture icon 803, a display shelf allocation check icon 804, and a stock replenishment icon 805. The robot management icon 802 is an icon for starting a mode of managing the product replenishment robot 1. The display shelf image capture icon 803 is an icon for starting a mode for the terminal device 3 to capture an image of the product display shelf.

The display shelf allocation check icon 804 is an icon for starting a mode of checking information registered by an operator on the part of the management apparatus 2 by the terminal device 3. The stock replenishment icon 805 is an icon for starting a mode of registering various items of information about product replenishment. In the following description, the user interface which is displayed after the display shelf image capture icon 803 is pressed will be described mainly.

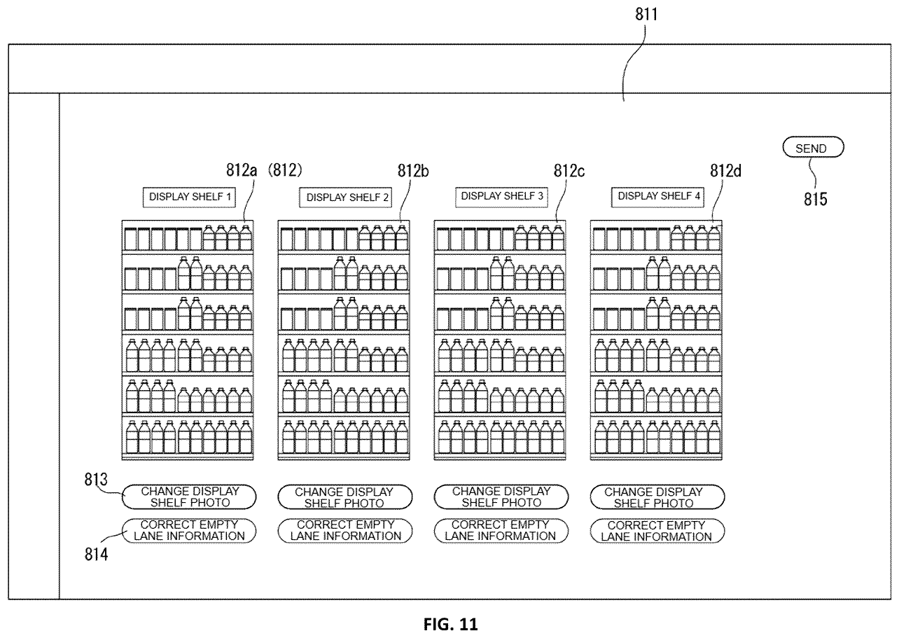

When the store employee presses the display shelf image capture icon 803, the terminal device 3 displays an operation screen 811 as shown in FIG. 11 on the display unit 31. The operation screen 811 includes shelf display sections 812a to 812d (also referred to as the shelf display section 812), a display shelf photo change icon 813, an empty lane information correction icon 814, and a send icon 815. The shelf display section 812 is an area where the image of the front side of the product display shelf captured by the store employee using the terminal device 3 is displayed. The number of shelf display sections 812 corresponds to the number of product display shelves in the store.

The display shelf photo change icon 813 is an icon for changing the photo displayed in the shelf display sections 812a to 812d. The empty lane information correction icon 814 is an icon for changing product information of an empty lane where no products are arranged. The send icon 815 is an icon for transmitting information changed by the store employee from the terminal device 3 to the management apparatus 2. In FIG. 11, the store employee captured an image of each product display shelf once in the past, and the image of the front side of the product display shelf captured at the time is displayed on each of the shelf display sections 812a to 812d as a default image.

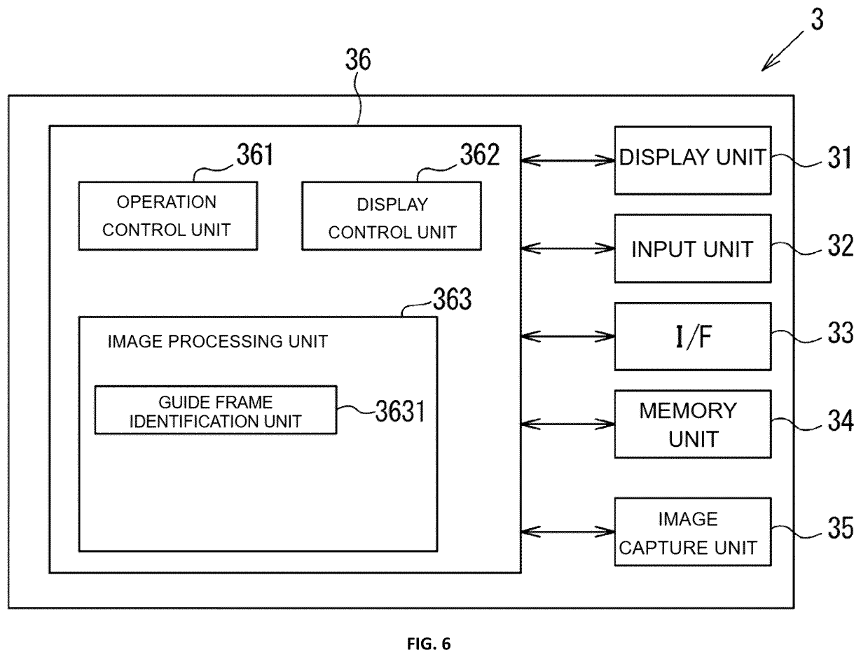

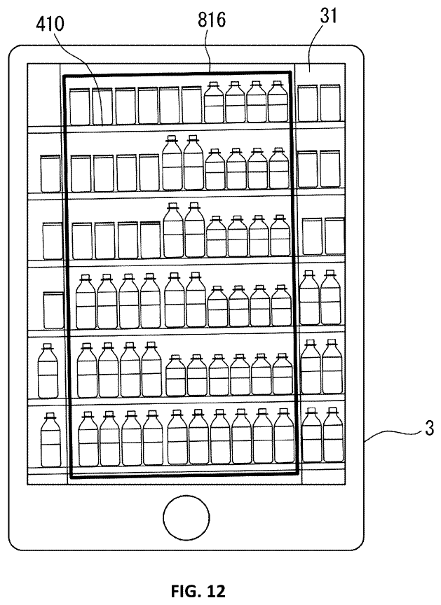

This time, the change in the layout of the products is in the “DISPLAY SHELF 1”. Therefore, the store employee presses the display shelf photo change icon 813 corresponding to the “DISPLAY SHELF 1”. Then, the image capturing function of the terminal device 3 is activated, and the image capture unit 35 of the terminal device 3 (see FIG. 6) becomes ready to capture an image of the product display shelf. In order to allow the store employee to capture an image of the entire product display shelf in a manner that product display shelf properly fits in the screen at the time of capturing the image of the product display shelf using the terminal device 3, the terminal device 3 may have a function of superimposing a guide frame 816 on the display shelf 410 captured by the image capture unit 35 and displaying the guide frame 816 on the display unit 31, as shown in FIG. 12.

Specifically, the guide frame identification unit 3631 (see FIG. 6), for example, recognizes one product display shelf 410 shown in the image, generates data for a guide frame 816 of the size surrounding one product display shelf 410, and the display control unit 362 superimposes the guide frame 816 on the captured image, and displays the superimposed guide frame on the display unit 31. Using this guide frame 816 as a reference, the store employee adjusts the image capture position in a manner that the product display shelf 410 fits into the guide frame 816, and captures an image of the product display shelf 410.

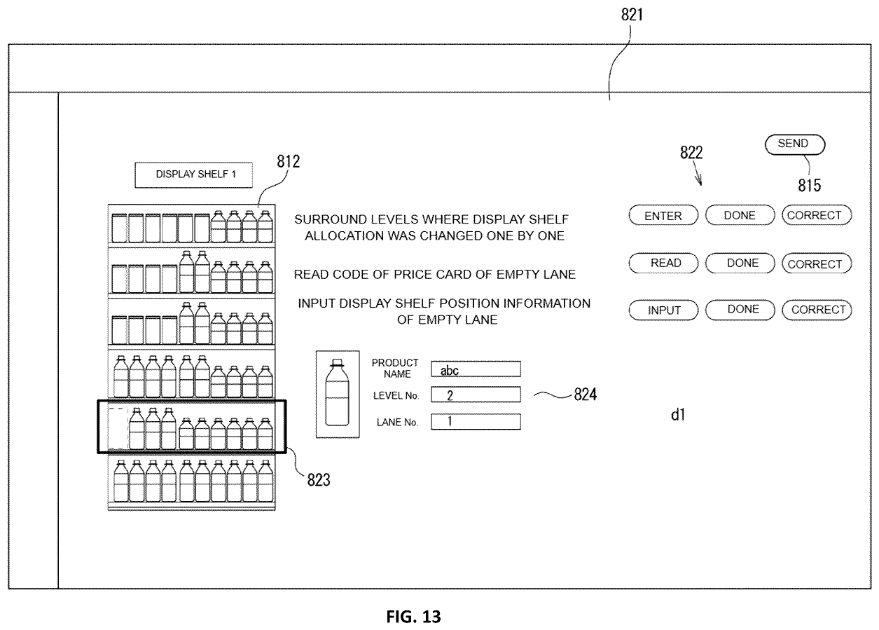

The store employee checks the captured image of “DISPLAY SHELF 1”, and if there seems to be no problem, presses a registration icon (not shown). Then, the terminal device 3 displays an operation screen 821 shown in FIG. 13. The operation screen 821 includes a shelf display section 812, a send icon 815, an information input icon 822, and an empty lane information display section 824. The image of the “DISPLAY SHELF 1” is displayed in the shelf display section 812.

The information input icon 822 includes a plurality of icons. The icon labeled “ENTER” is an icon used to designate a level of the shelf where the product has been changed. The icon labeled “DONE” is an icon pressed by the store employee when the shelf level designation is completed, and the icon labeled “CORRECTION” is an icon pressed by the store employee at the time of changing the range of shelf level designation. Firstly, the store employee presses the “ENTRY” icon and surrounds the level of the shelf where the product has been changed using a frame 823. The designation of the frame 823 may be made, for example, by the store employee who inputs one and its diagonal corner of a rectangle on the touch panel with a finger, to input the frame 823 of a size surrounding a single shelf level. When this operation is completed, the store employee presses the icon of “DONE”.

In the case where there is an empty lane (i.e., lanes where no products T are arranged) on the product display shelf, the store employee reads a code on a price card indicating product information, for example, attached to a lane of the product display shelf, so as to correctly register the products to be arranged in the empty lane as well. Further, the store employee inputs the display position information of the empty lane. In FIG. 13, for example, the empty lane information indicating that lane number 1 on the second level of the display shelf is an empty lane and information indicating that the product in the lane is “abc” is displayed in the empty lane information display section 824.

By the processes up to this point, an image of the front side of the display shelf where the layout of the products has been changed and the product information in the empty lanes, if any, are prepared. These items of information are transmitted from the terminal device 3 to the management apparatus 2 when the store employee presses the send icon 815 on the operation screen 821.

Next, in step S3 (see FIG. 7), for example, the store employee operates the product replenishment robot 1 to allow the product replenishment robot 1 to capture an image of the back side of the product display shelf. The product replenishment robot 1 captures an image of the back side of a predetermined level (e.g., the second level of the “DISPLAY SHELF 1”) where products have been changed on the product display shelf, and transmits the captured image to the management apparatus 2.

Next, processes performed by the management apparatus 2 in steps S4, S5, and S7 will be described. An application for the operator is installed in the management apparatus 2. In step S4, in order to register the product display shelf coordinates, the operator launches the application for the operator of the management apparatus 2.

The management apparatus 2 displays an operation screen 901 as shown in FIG. 14 on the display unit 21. The operation screen 901 is an executable task table which includes a task list display section 902 and a support start icon 903.

The task list display section 902 is a table containing task information which indicates what kind of support is needed by each of the stores or the product replenishment robots associated with the store IDs of the plurality of stores and/or the robot IDs of the product replenishment robots located in the stores, for which the operator logged into the management apparatus 2 is in charge of management. The support start icon 903 is displayed for each task, and the operator can select a task by pressing this support start icon 903.

In the “SUPPORT CONTENTS” column of the task list display section 902, task information such as “DISPLAY SHELF COORDINATE REGISTRATION”, “PRODUCT INFORMATION REGISTRATION”, “DISPLAY POSSIBILITY DETERMINATION”, “HOLDING TARGET RECOGNITION”, “PICK RECOVERY”, “PLACE RECOVERY”, and “OTHER RECOVERY” are displayed. The “DISPLAY SHELF COORDINATE REGISTRATION” is a task in which the operator registers coordinates of the lanes of the product display shelf and other information beforehand for allowing the product replenishment robot 1 to replenish products automatically. The “PRODUCT INFORMATION REGISTRATION” is a task in which the operator registers what kind of product is placed in each lane one by one.

The “DISPLAY POSSIBILITY DETERMINATION” is a task in which the operator determines and indicates whether or not a product can be displayed on the product display shelf in the case where the replenishment robot 1 cannot determine whether or not the product can be displayed on the product display shelf. The “HOLDING TARGET RECOGNITION” is a task used in the case where the product replenishment robot 1 cannot identify the product to be held on the stock shelf for allowing the operator to identify the target and provides instructions. “PICK RECOVERY” and “PLACE RECOVERY” are tasks in which the operator provide support in the case where an event which requires some assistance for the replenishment robot 1 to hold (PICK) the product or place (PLACE) the product occurs.

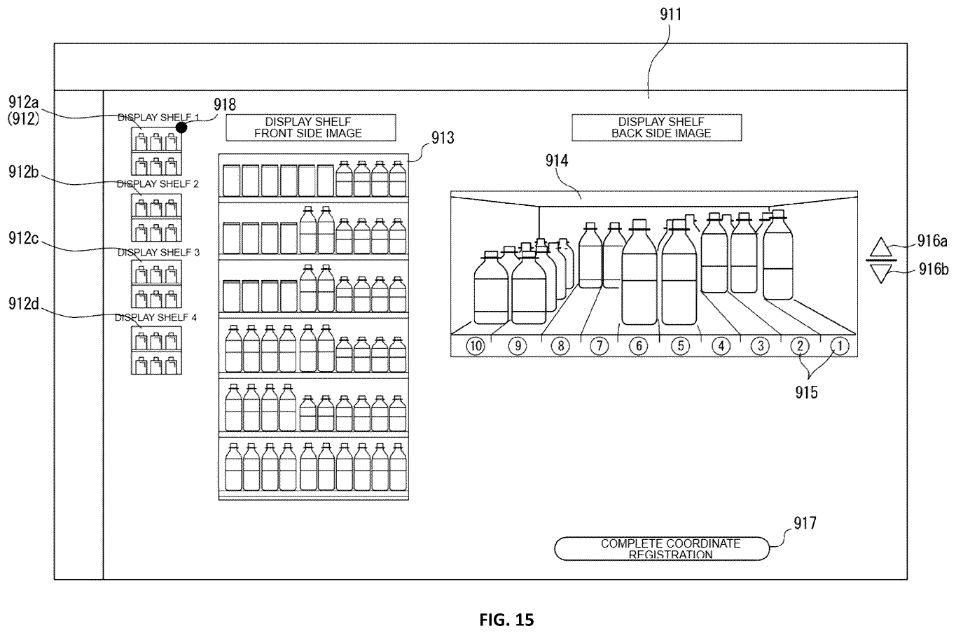

In step S3 (see FIG. 7), since the task is to register display shelf coordinates, the operator selects “DISPLAY SHELF COORDINATE REGISTRATION” of the target store from the task list display section 902, and presses the support start icon 903. Then, the management apparatus 2 displays an operation screen 911 shown in FIG. 15 on the display unit 21. The operation screen 911 includes shelf selection icons 912, a display shelf front side image 913, a display shelf back side image 914, lane coordinate display indicators 915, level change icons 916a and 916b, and a coordinate registration completion icon 917.

The shelf selection icon 912 is an icon for selecting one of the plurality of product display shelves. Four shelf selection icons 912a to 912d are displayed corresponding to the number of product display shelves in the store. In this operation screen 911, a notification badge 918 is displayed at the shelf selection icon 912a of the “DISPLAY SHELF 1”.

The display control unit 262 of the management apparatus 2 identifies the product display shelf on which the layout of products has been changed based on the information indicating the product display shelf on which the layout of products has been changed, transmitted from the terminal device 3. For the product display shelf where the layout of products has been changed, the display control unit 262 displays the notification badge 918, which is an indicator indicating the product display shelf which needs to be checked by the operator, on the shelf selection icon 912 corresponding to the product display shelf. According to the structure where the notification badge 918 is displayed in this manner, the operator can easily recognize for which product display shelf the work of coordinate registration (see below for details) should be performed.

The display shelf front side image 913 is an image of the front side of the product display shelf captured by the store employee using the terminal device 3. When the operator selects the shelf selection icon 912a, the display control unit 262 of the management apparatus 2 displays the image of the front side of the “DISPLAY SHELF 1” as the product display shelf front side image 913.

The display shelf back side image 914 is an image of the back side of the product display shelf captured by the product replenishment robot 1. The image of the back side of the product display shelf selected by the shelf selection icon 912 (in this case, “DISPLAY SHELF 1”) is displayed as the display shelf back side image 914. In this product display shelf back side image 914, the levels of the product display shelf on the screen have 10 lanes from “1” to “10”.

The lane coordinate display indicator 915 is information indicating the coordinates of each lane. In the present embodiment, the point annotation adding unit 2621 (see FIG. 5) of the management apparatus 2 analyzes the captured image of the back side of the shelf and identifies information of the coordinates of each lane (x-direction parallel to the lateral direction of the product display shelf and z-coordinate parallel to the vertical direction of the product display shelf). Then, indicators “1” through “10” are superimposed, and displayed on the back side image of the product display shelf in a manner that the indicators correspond to the positions of the respective lanes.

The coordinate information indicated by the lane coordinate indicator 915 is used by the product replenishment robot 1 at the time of performing the replenishment operation of the product T. Therefore, the coordinate information of each lane needs to be set correctly. As shown in the operation screen 911 of FIG. 15, according to the configuration in which the coordinates identified by the management apparatus 2 are displayed in the image in a clearly understandable manner as the lane coordinate display indicator 915, the operator can check the position of the lane coordinate display indicator 915 on the screen, and thus can check whether or not the coordinate information has been set correctly. After checking the location of the coordinates, the operator presses the coordinates registration completion icon 917.

If work needs to be done for the other levels of the product display shelf, the operator presses an upward triangle level change icon 916a or a downward triangle level change icon 916b. As a result, the image of the level one above or one below the currently displayed level is displayed. The management apparatus 2 may display a notification badge (not shown) near the level change icons 916a and 916b if work by the operator is needed for other levels as well. For example, if work by the operator is needed for the level above the level currently displayed as the display shelf back side image 914, a notification badge is displayed near the level change icon 916a.

### Product Information Registration

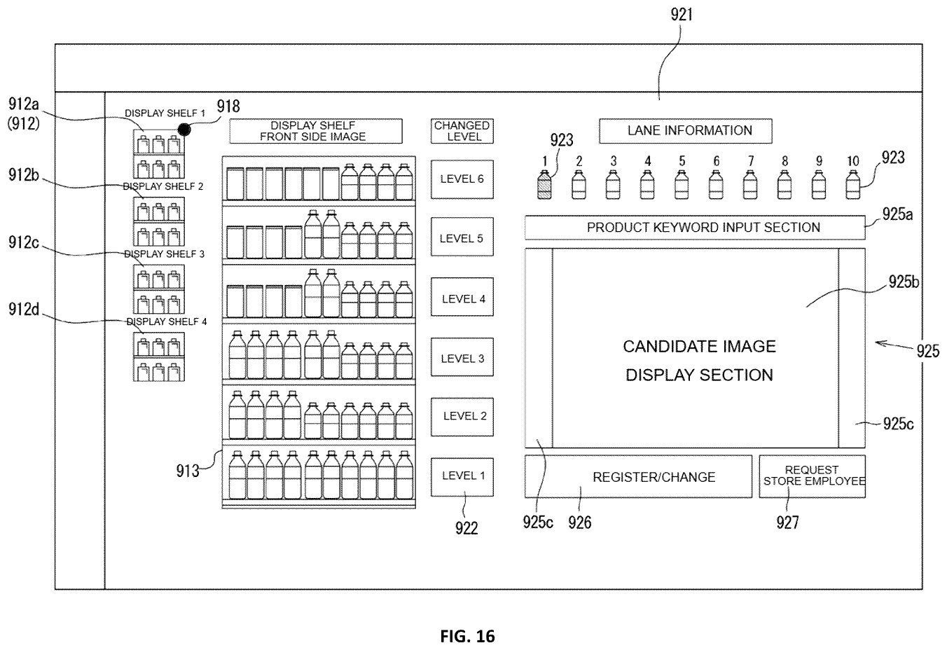

Next, in step S5 (see FIG. 7), the operator registers product information. In this process, the management apparatus 2 displays an operation screen 921 as shown in FIG. 16 on the display unit 21.

The operation screen 921 includes a shelf selection icon 912, a display shelf front side image 913, level selection icons 922, bottle icons 923, a product information input section 925, a registration/change icon 926, and a store employee request icon 927. Since the shelf selection icon 912 and the display shelf front side image 913 are identical to those displayed in FIG. 15, description thereof will be omitted.

The level selection icon 922 is an icon for selecting the level of the product display shelf, and in this example, the level selection icons 922 from “LEVEL 1”to “LEVEL 6” are displayed. The bottle icon 923 is an icon for selecting products on the product display shelf, and in this example, bottle icons 923 from “1” to “10” are displayed corresponding to the number of lanes. The product information input section 925 includes a product keyword input section 925a, a candidate image display section 925b, and a selection icon 925c.

The operator inputs information about the product on the operation screen 921 in the following procedure. Firstly, for example, the operator selects the second level among the level selection icons 922. Then, when the bottle icon 923 of, for example, “1” is selected by the operator, the management apparatus 2 is switched to a state for accepting the input of information about the product in the first lane of the second level. In this state, the operator inputs a product name in the product keyword input section 925a. The management apparatus 2 reads the image of the product corresponding to the inputted product name from the memory unit 25 and displays the image on the candidate image display section 925b.

There may be multiple designs for beverage products, even for the same product, due to differences in volume, for example. If the displayed product is not the desired product, the operator presses the left or right selection icon 925c. If the selection icon 925c is pressed, the management apparatus 2 reads another candidate image associated with the inputted product name from the memory unit 25 and displays the candidate image on the candidate image display section 925b.

The operator checks the inputted product name and the displayed product image, and if the registration is possible based on the information, presses the registration/change icon 926 to complete registration of the product information for the lane “1”. Thereafter, the same procedure is performed to register the product information for the target lane. In the case where predetermined support by a store employee is required for registration of the information about the product, the operator presses the store employee request icon 927 and informs the store employee of the details of the request. When the series of operations are completed and the operator presses the completion icon (not shown), the information inputted by the operator is registered in the management apparatus 2.

Thereafter, the management apparatus 2 transmits the registered information to the terminal device 3. Then, in step S6 (see FIG. 7), the store employee checks the registered information through the terminal device 3 and, if necessary, transmits a request for correction from the terminal device 3 to the management apparatus 2. Thereafter, in step S7, the operator generates final shelf allocation data, and registers the data in the management apparatus 2.

In the process flow described above, in the case where the layout of products on the product display shelve is changed, the store employee captures the image of the product display shelf using the terminal device 3, and based on the captured image, the operator uses the management apparatus 2 to register information of the product. As described above, in order to allow the product replenishment robot 1 to perform the automatic product replenishment operation, correct information about the product placement position and the product itself needs to be prepared in advance. According to the configuration of the present embodiment, since the user interfaces as shown in FIGS. 10 to 16 are displayed on the terminal device 3 and the management apparatus 2, it is possible for the store employee or the operator to perform predetermined work. In this manner, it is possible to create shelf allocation data for the product display shelve efficiently.

### Display Possibility Determination, Holding Object Recognition, and Pick/Place Recovery

Next, among the tasks performed by the operator, display possibility determination, holding target recognition, and Pick/Place recovery will be described one by one.

### A. Display Possibility Determination

As described above, the product replenishment robot 1 determines whether or not the product can be displayed in step S12 of FIG. 8. Specifically, the product replenishment robot 1 determines whether or not there is a space Sp (see FIG. 9) on the product display shelf where a product T can be displayed. In the case where the product replenishment robot 1 cannot determine whether or not there is a space Sp, the product replenishment robot 1 transmits a notification to the management apparatus 2 as an error notification indicating that it is not possible to determine that there is a space Sp. Further, the product replenishment robot 1 also transmits the captured image of the back side of the product display shelf to the management apparatus 2. The management apparatus 2 receives these error notifications and image data.

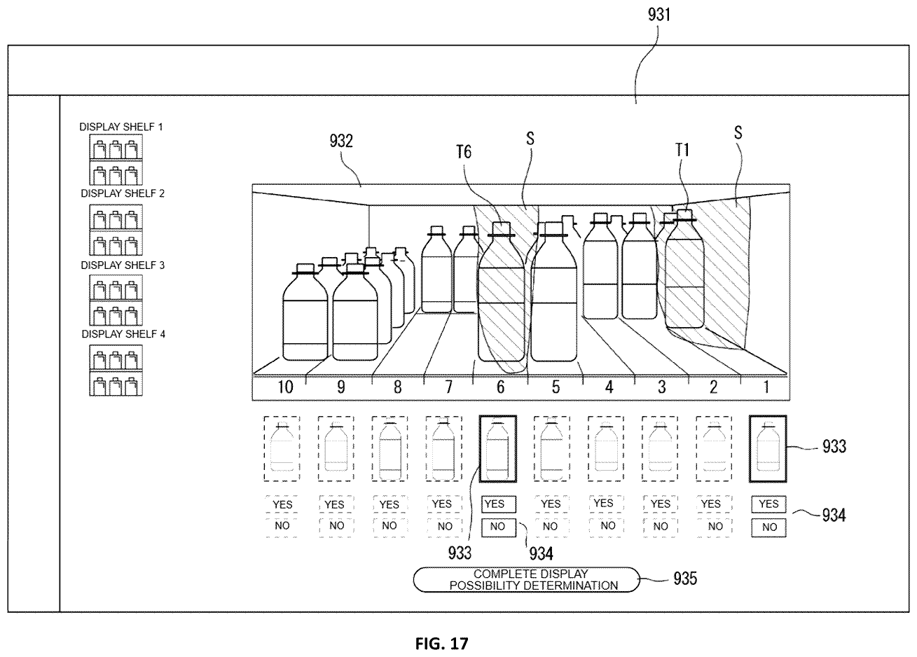

In the case where the operator selects “DISPLAY POSSIBILITY DETERMINATION” from the task list display section 902 (see FIG. 14) and presses the support start icon 903, the management apparatus 2 displays the operation screen 931 as shown in FIG. 17 on the display unit 21.

The operation screen 931 includes a product display image display section 932, product identification icons 933, instruction input icons 934, and a display possibility determination completion icon 935. The product identification icons 933, the instruction input icons 934, and the display possibility determination completion icon 935 are instruction input user interfaces for accepting instructions of the operator.

The product display image display section 932 is a window in which an image of the back side of the product display shelf transmitted from the product replenishment robot 1 is displayed. In this image, as an example, an area near the rearmost product T1 in the lane “1” is darkened by a shadow S. Therefore, it is not possible for the product replenishment robot 1 to determine whether or not there is a space behind the product T1 where the product can be displayed. Likewise, also in the lane “6”, an area near the last product T6 is darkened by a shadow S. Therefore, this is a situation where the product replenishment robot 1 cannot determine whether or not there is a space behind the product T6 where the product can be displayed.

The management apparatus 2 identifies the lane where the product replenishment robot 1 could not determine the presence or absence of the space, and displays the product identification icons 933 for lanes “1” and “6” in a highlighted state so that the management apparatus 2 can accept instructions from the operator for the identified lanes “1” and “6”. The product identification icons 933 for the other lanes are grayed out. It is a matter of course that the product identification icons 933 may be displayed in a manner other than “highlighted” and “grayed out” as long as it is possible to distinguish between the lanes which require work by the operator and the other lanes.

For example, the operator selects the product identification icon 933 for the lane “1”, checks whether or not the product can be placed behind the product T1 by looking at the image of the back side of the product display shelf, and then, selects the instruction input icon 934 of either “YES” or “NO”. In this case, although the area near the product T1 is darkened by the shadow S, there is a space behind the product T1 where the product can be placed. Therefore, the operator selects the instruction input icon 934 of “YES”.

Next, the operator selects the product identification icon 933 for the lane “6” to check whether or not the product can be placed behind the product T6, and selects either “YES” or “NO”. In this case, the operator selects the instruction input icon 934 of “NO”, because the product cannot be placed behind the product T6.

After completion of the above input, the operator presses the display possibility determination completion icon 935. When the display possibility determination completion icon 935 is pressed, the management apparatus 2 transmits the information of “YES” or “NO” inputted by the operator to the product replenishment robot 1. According to the management apparatus 2 and the product replenishment robot 1 of the present embodiment, even if the product replenishment robot 1 cannot correctly determine whether or not a product can be displayed, the operator can provide instructions through the operation screen 931 displayed on the management apparatus 2. Thus, the product replenishment robot 1 can continue its product replenishment operation without the need for support by the store employee in the store.

### B. Recognition of the Holding Target

As described above, the product replenishment robot 1 captures the image of the stock shelf 420 in step S14 of FIG. 8 and identifies the product of the holding target. In the case where the product replenishment robot 1 cannot determine the product as the holding target, the product replenishment robot 1 transmits a notification indicating that it is not possible to determine the product as the holding target, to the management apparatus 2 as an error notification. The product replenishment robot 1 also transmits the captured image of the stock shelf 420 to the management apparatus 2. It is assumed that the cases where it is not possible to determine the product as the holding target include, for example, a case where it is not possible to determine which product is placed at the frontmost position among the products in a predetermined lane of the stock shelf 420, a case where it is not possible to determine what the product is, a case where it is not possible to identify the size of the product, and a case where it is not possible to identify the shape of the product.

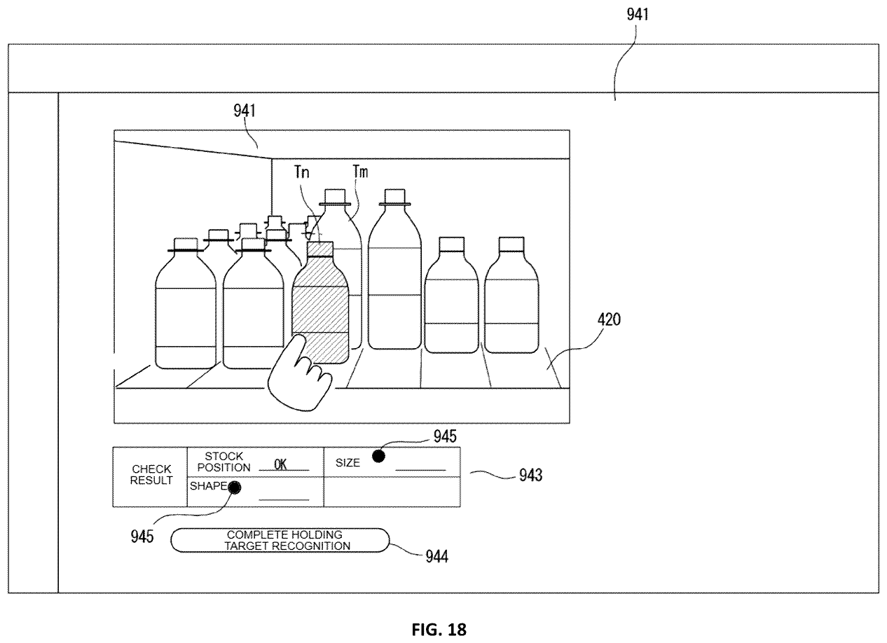

In the case where the operator selects “HOLDING TARGET RECOGNITION” from the task list display section 902 (FIG. 14) and presses the support start icon 903, the management apparatus 2 displays an operation screen 941 as shown in FIG. 18 on the display unit 21. The operation screen 941 includes a shelf image display section 942, a product information input section 943, and a holding target recognition completion icon 944. The product information input section 943 and the holding target recognition completion icon 944 are instruction input user interfaces for accepting instructions of the operator. Specifically, the product information input section 943 corresponds to a shape designation user interface and a size designation user interface.

The shelf image display section 942 is a portion where the image of the front side of the stock shelf 420 captured by the product replenishment robot 1 is displayed. In this example, in the third lane from the left of the stock shelf 420, products Tn and Tm of different types are placed in the same lane. If the product replenishment robot 1 cannot identify which product should be held in this situation, the management apparatus 2 displays a tool for the operator to designate the product, together with the image transmitted from the product replenishment robot 1. The management apparatus 2 distinguishes (image segmentation), for example, between the products Tn and Tm by image recognition, and displays the products Tn and Tm in different display modes (e.g., in different colors).

The management apparatus 2 recognizes whether the operator has selected the product Tn or the product Tm, and identifies the selected product as the holding target. In the case where the management apparatus 2 has a touch panel display, as shown in FIG. 18, for example, in response to touching of the product Tn by the operator, the display control unit 262 of the control unit 26 identifies the touched product as the holding target. As described above, the interface for designating the target product on the screen is a product designation user interface among the instruction input user interfaces for accepting instructions of the operator.

The product information input section 943 displays the results of image recognition by the product replenishment robot 1 and includes the items “stock position”, “size”, and “shape”. In this example, the stock position of the target product is correctly identified. A notification badge 945 is displayed in each of the items “size” and “shape”, and the notification badge 945 indicates that the size and the shape of the product were not correctly identified.

When the notification badge 945 is displayed, the operator recognizes that the correct information needs to be inputted for these items. The operator checks the target product by looking at the image on the shelf image display section 942, and inputs information of the “size” and “shape” of the product through the product information input section 943. It should be noted that the specific user interface for inputting these items of information is not limited specially. For example, it is possible to adopt an interface where a pop-up window or a pull-down window is displayed on the operation screen 941, and one of several candidates displayed in the window is selected. For example, candidates for products such as “PET bottle 500 ml”, “PET bottle 350 ml”, “canned beverage 350 ml”, and “canned beverage 190 ml” may be displayed.

After completion of the above input, the operator presses the holding target recognition completion icon 944. Then, the management apparatus 2 transmits the information inputted by the operator to the product replenishment robot 1.

Using the management apparatus 2 and the product replenishment robot 1 of the present embodiment, even in the case where the product replenishment robot 1 cannot correctly determine the target holding product, the operator can provide instructions through the operation screen 941 displayed on the management apparatus 2, and as a result, the product replenishment robot 1 can continue the product replenishment operation without the need for support by the store employee in the store.

### C. Pick/Place Recovery

As described above, in step S15 of FIG. 8, the product replenishment robot 1 holds (Pick) the product on the stock shelf 420 in step S15 of FIG. 8, moves the product to the product display shelf 410, and places the product in a predetermined position on the product display shelf 410 (Place). In this series of operations, in the case where the replenishment robot 1 cannot correctly hold the target product or cannot correctly place the target product, the product replenishment robot 1 transmits a notification to this effect, to the management apparatus 2.

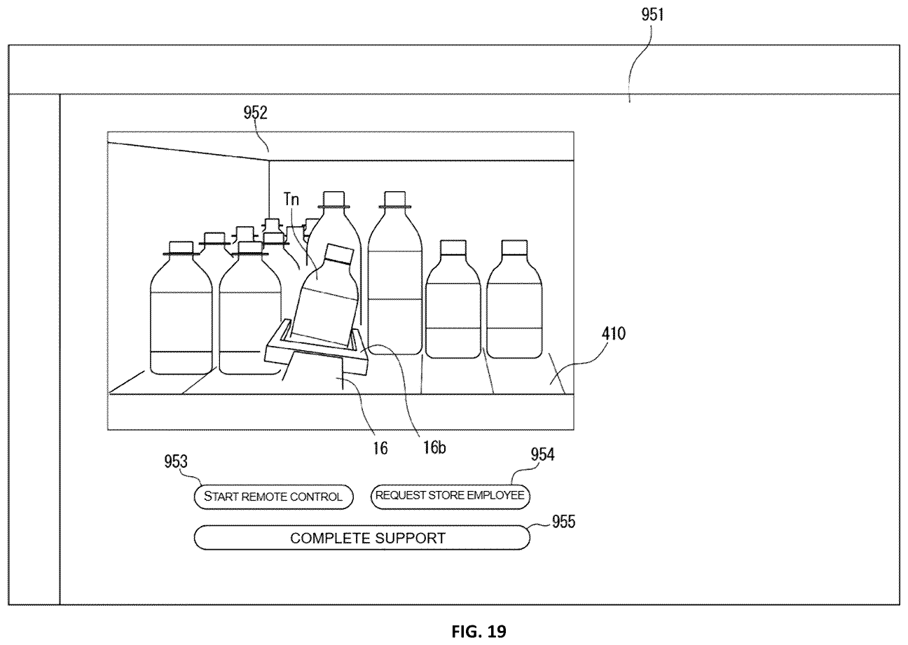

In the case where the operator selects, for example, “PICK RECOVERY” from the task list display section 902 (FIG. 14) and presses the support start icon 903, the management apparatus 2 displays an operation screen 951 as shown in FIG. 19 on the display unit 21. The operation screen 951 includes a shelf image display section 952, a remote control start icon 953, a store employee request icon 954, and a support completion icon 955. The remote control start icon 953, the store employee request icon 954, and the support completion icon 955 are instruction input user interfaces for accepting instructions of the operator.

It should be noted that both of “PICK RECOVERY” and “PLACE RECOVERY” are performed by the operator by remote control of moving the robot arm 16 while viewing the image captured by the image capture unit 18. So, in the following description, “Pick Recovery” will be taken as an example.

While the shelf image display section 942 may display a still image of the stock shelf 420 captured by the product replenishment robot 1, in the present embodiment, streamed video is displayed to enable smooth remote control by the operator as described later. That is, in the present embodiment, the display control unit 262 of the management apparatus 2 displays video data transmitted from the product replenishment robot 1 on the shelf image display section 952 of the display unit 21 in real time concurrently with reception of the data.

In the case where the operator checks the operation screen 951 and determines that the target product Tn can be moved to the correct position by remote control of the product replenishment robot 1, the operator presses the remote control start icon 953. Then, the product replenishment robot 1 is switched to the remote control mode, where the image capture unit 18 and robot arm 16 can be operated according to instructions from the management apparatus 2.

The operator checks the image of the current stock shelf 420 displayed on the shelf image display section 942, and holds the target product Tn at a predetermined position using the holder unit 16b of the robot arm 16, for example, by operating the operation unit 23 of the management apparatus 2. Then, the operator uses the robot arm 16 to correct the posture of the product Tn or shift the placement position to place the product Tn at a predetermined position.

When the operator completed support by remote control, the operator presses the support completion icon 955. When the support completion icon 955 is pressed, the management apparatus 2 transmits a notification of support completion to the product replenishment robot 1. Upon receipt of this notification, the product replenishment robot 1 resumes the automatic replenishment operation of the product which was temporarily interrupted to receive support of the operator.

In the case where the operator checks the operation screen 951 and determines that it is not possible to move the target product Tn to the predetermined position by remote control, or in the case where the remote control described above has not been successful in moving the target product Tn to the predetermined position, the operator presses the store employee request icon 954. When the store employee request icon 954 is pressed, the management apparatus 2 sends a notification to this effect to, for example, the terminal device 3.

When the terminal device 3 receives the notification transmitted from the management apparatus 2, the terminal device 3 outputs alert information (voice, text, or image information, etc.) indicating that support by the store employee is required with respect to the operation of the product replenishment robot 1 from the output unit such as the speaker or the display (not shown). The management apparatus 2 may transmit, as information for the store employee, detailed information indicating information about the operation which requires support (e.g., at least one of the still image data of the shelf captured by the product replenishment robot 1, video data of the shelf captured by the product replenishment robot 1, date and time information, information identifying the target product, position information of the work target, etc.), to the terminal device 3.

In the management apparatus 2 and the product replenishment robot 1 of the present embodiment, even in the case where an event requiring support such as a failure in holding the product correctly occurs during the automatic product replenishment operation by the product replenishment robot 1, the operator at the remote location provides support by remote control, and then, the product replenishment robot 1 can resume the unmanned product replenishment operation.

Further, the operator can also request support of the store employee of the store by pressing the store employee request icon 954 on the operation screen 951 which is a calling user interface for prompting the store employee or the worker in the vicinity of the robot to provide assistance. Therefore, even if an event which cannot be handled by the operator at the remote location occurs, the operator can prompt the store employee to assist and return to a situation where the product replenishment robot 1 performs the replenishment operation automatically, and thereafter, the product replenishment robot 1 can continue the replenishment operation.

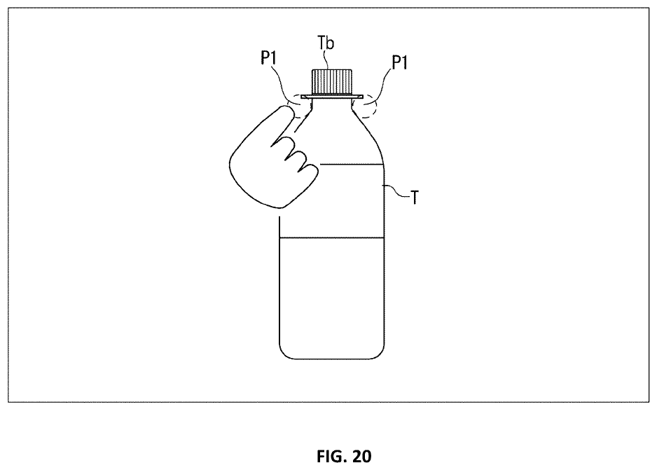

While the examples of specific operation screens have been described above with reference to the drawings, the following operation screen may be displayed on the display unit 21 of the management apparatus 2. FIG. 20 is an operation screen for the operator to support the holding position when the product replenishment robot 1 cannot identify the holding position of the replenishment target product. When the product replenishment robot 1 cannot identify the holding position of the replenishment target product, a notification to this effect is transmitted to the management apparatus 2 together with a captured image of the stock shelf.

When the display control unit 262 of the management apparatus 2 receives this notification, the display control unit 262 enables the operation screen as shown in FIG. 20 to be displayed on the display unit 21. For example, the operator selects the task of “HOLDING POSITION IDENTIFICATION” (not shown). As a result, the operation screen shown in FIG. 20 is displayed on the display unit 21. In this case, since the product T in the image is a PET bottle beverage having a cap member Tb, the operator indicates, for example, a position near the cap member Tb as the holding position P1.

The operation screen shown in FIG. 20 functions as an instruction input user interface for accepting operator instructions. Therefore, even in the case where the product replenishment robot 1 cannot identify the holding position, the operator at the remote location can provide an instruction of the holding position P1 of the replenishment target product. Thus, the product replenishment robot 1 can continue the replenishment operation.

The management apparatus 2 may accept the body part of the product T as the holding position P1, instead of the position near the cap member Tb of the product T. In the case where the management apparatus 2 has the structure as described above, for example, even when it is not possible to hold the area near the cap member Tb due to the shape of the product display shelf or the robot arm, the operator can operate the robot arm of the robot to hold an appropriate position.

In addition to the above, with respect to the placement of products by the product replenishment robot 1, the management apparatus 2 may display an operation screen for providing an instruction of the position where the product should be placed or an instruction of whether or not the target product can be placed on the display unit 21.

### Robots for Applications Other Than Beverage Display

In the above embodiment, the operation screens which can be particularly useful in the system where a beverage product is moved from the stock shelf 420 to the product display shelf 410 by the product replenishment robot 1 has been described. However, the operation screens described above can also be used, for example, in a system having a work robot which moves work target products using a robot arm and a management apparatus which remotely controls the work robot. As described above, such work robots may be robots which hold products in logistics facilities and robots which hold predetermined products in factories, etc.

Also in such a system, it is preferable that the operation screen displayed on the management apparatus at the remote location has one or more of, for example, a user interface for accepting an operator's designation of one or more target products, a user interface for designating the shape of the product, a user interface for designating the size of the product, and a user interface for prompting an operator, etc., in the vicinity of the robot to provide assistance.

Since there are various types of “errors” in various types of work robots, any content can be transmitted from the work robot to the management apparatus. However, when the management apparatus receives predetermined error information from the work robot, the management apparatus displays an operation screen including a capture image showing the work target of the work robot and an instruction input user interface for accepting instructions of the operator on the predetermined display unit.

Assuming that the work robot is operated to hold a package such as cardboard boxes, for example, when it is not possible to identify the target package, or when the target package is identified correctly, but it is not possible to correctly hold the identified target package, the robot may determine that an “error” has occurred, and a notification indicating the error may be transmitted to the management apparatus.

In a management system where one management apparatus manages a plurality of stores or a plurality of robots, it is possible to assume a configuration where one management apparatus is used by several operators. In this case, in a possible configuration, the robot and/or store that each of a plurality of operators is in charge of are linked to the operator's ID and managed, and the management apparatus displays tasks of the robot and/or store that the operator is in charge of on the display unit based on the ID of the current operator who is logged in.

### Working Effect of the Management Apparatus 2

In the management apparatus 2 of the present embodiment described above, based on at least one of the image captured by the image capture unit 18 of the product replenishment robot 1 and the detection result by the distance detection unit 19, the product replenishment robot 1 receives a notification indicating that it is not possible to identify the target, a notification indicating that it is not possible to hold the target product, and/or a notification indicating that it is not possible to place the product, and based on receipt of the notification, enables the operation screens (931, 941, 951, etc.) to be displayed. Further, these operation screens include an image captured by the image capture unit 18 and an instruction input user interface for accepting instructions of the operator regarding the products shown in the captured image. Therefore, the operator can provide instructions through the operation screen displayed on the management apparatus 2, and as a result, the product replenishment robot 1 can continue to perform the predetermined work without the need for support by the store employee in the store.

Although the present invention has been described using the embodiments, the technical scope of the present invention is not limited to the scope described in the above embodiments, and various modifications and changes can be made within the scope of the gist of the present invention. For example, all or part of the apparatus, in any unit, can be configured to be functionally or physically distributed or integrated. Further, any new form of embodiments derived from any combination of a plurality of embodiments are also encompassed within the embodiments of the present disclosure. The effects of the new form of embodiments derived from combination of embodiments have the effects of the original embodiments as well.

It should be understood by those skilled in the art that the disclosure of the invention in the above embodiments as a method of executing a predetermined process by an apparatus and a computer is also disclosed as the invention of a program for operating the apparatus and the computer.

1. A management apparatus configured to manage a robot which identifies a product as a target of work based on at least one of a capture image captured by an image capture unit and a detection result by a distance detection unit, and which performs work including holding of the identified product;
a receiver unit configured to receive a notification indicating a predetermined error transmitted from the robot; and
a display control unit configured to enable an operation screen to be displayed on a display unit based on receipt of the notification by the receiver unit;
wherein the operation screen includes a capture image captured by the image capture unit of the robot and an instruction input user interface for accepting an instruction of an operator regarding a product shown in the capture image.

2. The management apparatus according to claim 1, wherein the instruction input interface includes a product designation user interface for accepting a designation of one or a plurality of target products, among one or a plurality of products shown in the capture image.

3. The management apparatus according to claim 1, wherein the instruction user input interface includes at least one of a shape designation user interface for designating a shape of the product of as the target of work, and a size designation user interface for designating a size of the product as the target of work.

4. The management apparatus according to claim 1, further comprising a calling user interface for prompting a store employee or a worker in the vicinity of the robot to provide assistance.

5. The management apparatus according to claim 1, wherein the notification indicating the predetermined error is at least one of:
a notification indicating that it is not possible to identify the product as the target of work;
a notification indicating that it is not possible to hold the product as the target of work; and
a notification indicating that it is not possible to place the product as the target of work,
the robot is a robot configured to hold a product placed on a stock shelf, and place the held product on a product display shelf;
a plurality of products placed on a shelf plate of the product display shelf or a plurality of products placed on a shelf plate of the stock shelf are displayed in the capture image of the operation screen; and
the instruction input user interface includes:
a user interface for allowing the operator to identify a product among the plurality of products, in relation to
a product which could not be identified by the robot,
a product which could not be held by the robot, or
a product which could not be placed on the shelf plate, by the robot;
a user interface for allowing the operator to input whether or not the product can be held or to input a holding position of the product; or
a user interface for allowing the operator to input whether or not the product can be placed or to input a position where the product is placed.

6. The management apparatus according to claim 5, wherein the instruction input user interface is configured to distinguishably display the product which could not be identified by the robot, the product which could not be held by the robot, or the product which could not be placed on the shelf plate, by the robot, and the other products.

7. The management apparatus according to claim wherein the instruction input user interface further comprises:
an icon for changing the capture image to a capture image of a shelf plate above a shelf plate currently displayed; and
an icon for changing the capture image to a capture image of a shelf plate below the shelf plate currently displayed.

8. The management apparatus according to claim 5, wherein the instruction input user interface further comprises a display shelf user selection interface for selecting one of a plurality of the product display shelves; and
the shelf selection interface includes an indicator indicating the product display shelf which needs checking operation by the operator.

9. The management apparatus according to claim 5, wherein the display control unit is configured to identify a position of each product in the stock shelf or the product display shelf or a position of a lane based on the capture image captured by the image capture unit, and superimposes and displays information indicating the position on the capture image of the stock shelf or the product display shelf.

10. The management apparatus according to claim 5, wherein the robot is configured to determine whether or not the product placed on the stock shelf is a holding target, and in the case where the product cannot be identified as the holding target, transmit a notification indicating that it is not possible to identify the product, to the management apparatus; and
the display control unit is configured to enable the operation screen to be displayed based on receipt of the notification indicating that it is not possible to identify the product.

11. The management apparatus according to claim 5, wherein the robot is configured to make display possibility determination to determine whether or not there is a space for displaying the product on a shelf plate of the product display shelf, and
in the case where it is not possible to make display possibility determination, transmit a notification to the effect that it is not possible to make display possibility determination to the management apparatus; and
the display control unit is configured to enable the operation screen to be displayed based on receipt of the notification indicating that it is not possible to make the display possibility determination.

12. The management apparatus according to claim 1, wherein the receiver unit is provided to receive the notification transmitted from a plurality of the robots; and
the display control unit is configured to display an execution task table including identification information of each of the robots which transmitted the notification and content of required support on the display unit.

13. A management system comprising:
a robot configured to identify a product as a target of work based on at least one of a capture image captured by an image capture unit and a detection result by a distance detection unit, and perform work including holding of the identified product; and
the management apparatus according to claim 1, any connected to the robot through a network.

14. A management method of managing a robot which identifies a product as a target of work based on at least one of a capture image captured by an image capture unit and a detection result by a distance detection unit, and which performs work including holding of the identified product;
the method comprising the steps of:
receiving a notification indicating a predetermined error transmitted from the robot, by the management apparatus; and
enabling an operation screen to be displayed on a display unit based on receipt of the notification by the management apparatus, wherein the operation screen includes:
a capture image captured by the image capture unit of the robot; and
an instruction input user interface for accepting an instruction of an operator regarding a product shown in the capture image.

15. A non-transitory computer program product for managing a robot, the non-transitory computer program product having computing program instructions thereon, wherein the computing program instructions when executed by one or more processors, configure a robot to identify a product as a target of work based on at least one of a capture image captured by an image capture unit and a detection result by a distance detection unit, and which performs work including holding of the identified product,
wherein the wherein the one or more processors is further configured to:
receive a notification indicating a predetermined error transmitted from the robot, by the management apparatus; and
enable an operation screen to be displayed on a display unit based on receipt of the notification by the management apparatus, wherein the operation screen comprises:
a capture image captured by the image capture unit of the robot; and
an instruction input user interface for accepting an instruction of an operator regarding a product shown in the capture image.
